(19) United States
(12) Patent Application Publication
(10) Pub. No.: US 2003/0130879 A1
(43) Pub. Date: Jul. 10, 2003

(54) Workstation management tool

(75) Inventors: Carol DelGaudio, Williston, VT (US); James D. Hilbrands, Longmont, CO (US); James A. Martin JR., Endicott, NY (US); William M. Houston, Williston, VT (US)

Correspondence Address: John R. Pivnichny, IBM Corporation, N50/040-4, 1701 North Street, Endicott, NY, 13760, US

(73) Assignee: International Business Machines Corporation, Armonk, NY

(21) Appl. No.: 10/040,844

(22) Filed: Jan. 7, 2002

(51) Int. Cl. G06F 17/60

(52) U.S. Cl. 705/8

(57) ABSTRACT

Employee workstations are managed throughout their entire lifecycle from initial planning to final disposal using an integrated software tool and method. A customer account manager application is used to define financial relationships of the owners of the workstations. Coupled thereto is a workstation planning and deployment manager application which is used to define capital plans for workstations for the owners. A client information manager application coupled to the workstation planning and deployment manager application maintains information about the owners and is adapted to accept entry of deployment information of workstation to owners. An asset information manager application maintains capital asset information such as serial number, location, and book value for the workstations. The asset information manager application receives updates from the client information manager application and provides input to the workstation planning and deployment manager application.

### TECHNICAL FIELD

The invention relates to systems and processes for managing computer workstations in an organization or business. More particularly the invention relates to the planning, allocation, assignment, provision, replacement, disposal, and financial recording of such computer workstations.

### BACKGROUND OF THE INVENTION

Within the information technology services industry, providing workstations to the employees in a client business, is an important service from a financial and customer satisfaction perspective. Employees typically will want the newest most powerful hardware in order to perform their tasks as easily and quickly as possible. These tend to be very expensive and rapidly depreciate in value. Company managers focus on controlling cost, albeit consistent with good productivity, and therefore limit spending on such hardware to what is the minimum needed for employees to get their jobs done. A service provider attempts to use skills, experience, and tools to manage the total workstation requirements over a period of time to optimize the entire process. The development of improved and innovative tools to perform such workstation management would therefore constitute a significant contribution to the art.

Storch et al. in U.S. Pat. No. 5,920,846 describe a system and method for handling telecommunication line service for customers. Although their system includes a capability for processing information indicating whether line conditioning termination equipment is installed at the customer premise, it is primarily directed to dispatching a line technician to a customer premise in response to a request for telecommunication line service provided by a telecommunication company. U.S. Pat. No. 5,920,846 is incorporated herein by reference in its entirety.

### OBJECTS AND SUMMARY OF THE INVENTION

It is therefore a principal object of the present invention to enhance the information technology service providing art by providing an enhanced tool for managing the lifecycle of workstations.

It is another object to provide such a tool wherein enhanced workstation management capabilities are possible.

It is a further object to provide a method of lifecycle management for workstations with novel capabilities.

It is yet another object to provide a computer program product for instructing a processor to manage lifecycles of workstations.

These and other objects are attained in accordance with one embodiment of the invention wherein there is provided an integrated lifecycle management tool for workstations, comprising, a customer account manager application for defining financial relationships of owners of the workstations, a workstation planning and deployment manager application for defining capital plans for the workstations, a client information manager application for maintaining information about the owners of the workstations and for entering deployment information of workstations to owners, and an asset information manager application for maintaining capital asset information for the workstations, and for receiving updates from the client information manager application.

In accordance with another embodiment of the invention there is provided a method of lifecycle management of workstations, the method comprising the steps of, defining financial relationships of owners of the workstations, defining capital plans for the workstations, maintaining information including deployment information about the owners of the workstations, and maintaining capital asset information for the workstations, including receiving updates based on the deployment information.

In accordance with another embodiment of the invention there is provided a computer system for managing lifecycles of workstations, the system comprising, means for defining financial relationships of owners of the workstations, means for defining capital plans for the workstations, means for maintaining information including deployment information about the owners of the workstations, and means for maintaining capital asset information for the workstations, including receiving updates based on the deployment information.

In yet another embodiment of the invention there is provided a computer program product for instructing a processor to manage lifecycles of workstations, the computer program product comprising, a compute readable medium, first program instruction means for defining financial relationships of owners of the workstations, second program instruction means for defining capital plans for the workstations, third program instruction means for maintaining information including deployment information about the owners of the workstations, and fourth program instruction means for maintaining capital asset information for the workstations, including receiving updates based on the deployment information, and wherein all the program instruction means are recorded on the medium.

### BRIEF DESCRIPTION OF THE DRAWINGS

FIG. 1 shows process steps in workstation management;

FIG. 2 illustrates a functional block diagram of the tasks performed at various process steps;

FIG. 3 shows elements of a tool for managing workstations; and

FIG. 4 relates process steps and elements of a workstation management tool.

### BEST MODE FOR CARRYING OUT THE INVENTION

For a better understanding of the present invention, together with other and further objects, advantages and capabilities thereof, reference is made to the following disclosure and the appended claims in connection with the above-described drawings.

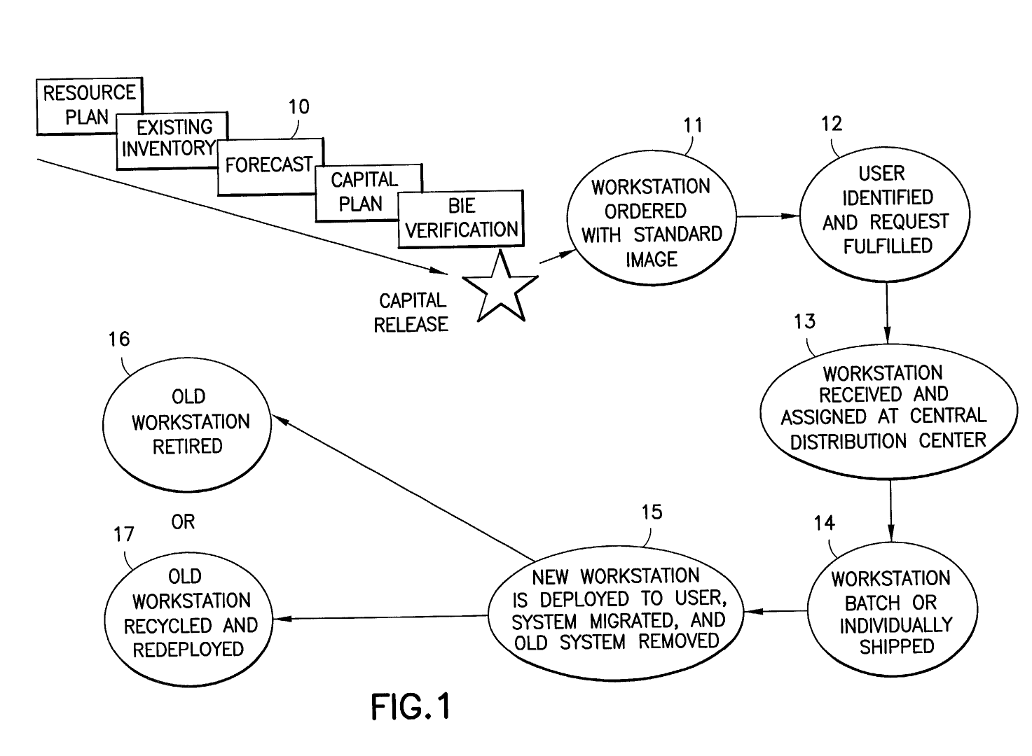

The workstation lifecycle management method of the present invention depicted in FIG. 1 is preferably implemented on a server computer system accessible by information technology service providing employees. However any type of computer system may be used including a plurality of processors of any type whether mainframe, personal computers, portables, laptops, or other. In step 10 a capital plan is developed. Inputs to the capital plan include a resource plan describing the number and type of client employees needing workstation service support. The resource plan typically covers a period of time such as one or several years broken down by quarter, month or some other period of time for which the client or service provider makes business decisions on capital releases. The resource plan may include new hires (for which a workstation will be needed at or shortly after the hiring date), departures, transfers, temporary workers, and supplemental employees as well as permanent employees assigned to various business units and locations within the client organization.

The capital plan of step 10 also includes inputs of an existing inventory of workstations which may include hardware type e.g. processor, display, printer, or scanner, the hardware age and book value. A standard offering configuration may be defined. An upgrade percentage may be specified for existing workstations. From the above inputs, a forecast of workstations and capital requirements is calculated for each period of time for capital releases typically quarterly. The forecast is submitted to a finance organization and to a business unit information executive (BIE) for approval. The BIE or a representative designated by the BIE may also allocate workstations to a particular group or to individual employees in a respective business unit.

Capital funds are therefore released as approved and in step 11 workstations are ordered. Workstations herein is taken to mean any hardware or software items provided to a client employee as part of an information technology service for the client. The workstations may be a complete system, a single element e.g. processor only, or a feature of an element such as additional memory or a larger hard drive or a new version of a software application. The workstation may be a desktop, laptop, portable, palm device, or any other type of information technology product. If a standard offering configuration is defined above, then workstations will be ordered configured with this standard offering (also referred to as a standard image) in step 11.

In step 12, individuals are selected, if not already designated by the BIE, to receive the workstations ordered in step 11. The ordered workstations are received in step 13. Receipt may be at a central distribution center, receiving area, or any suitable location. In step 14 the workstations are shipped to the individuals selected in step 12 above.

When the workstation is a processor, applications unique to the business unit of the selected individual (BIE applications) are added to the workstation in step 15. The new hardware is also deployed, and installed in step 15 and the old hardware is removed.

The old workstation hardware is retired from service (disposed as unusable) in step 16 or else it is recycled and redeployed (cascaded to the next person who will receive it) in step 17. Records of all the above actions are kept using a customer account manager application, a workstation planning and deployment manager application, a client information manager application and an asset information manager application which interact and when taken together comprise an integrated lifecycle management tool for workstations as described below.

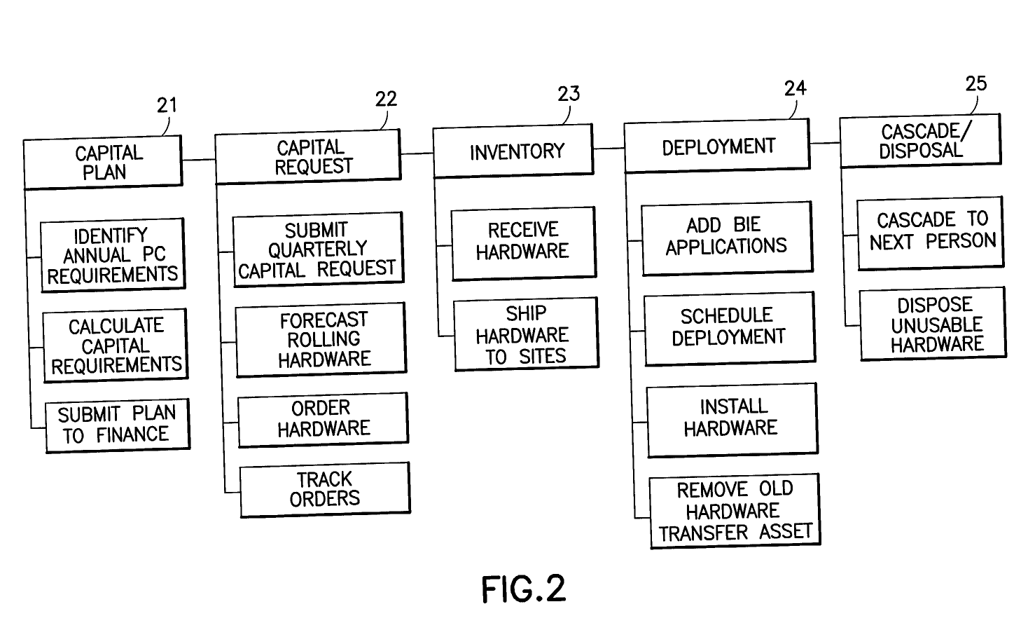

A functional block diagram showing tasks which may be performed at various process steps is illustrated in FIG. 2. Formation of capital plan 21 may include identifying workstation requirements. The workstations may be a personal computer (PC) and the identification may be made to cover any period of time, typically annually. The capital requirements to acquire workstations are then calculated and a capital plan presented to a finance organization for approval.

A capital request 22 is then periodically, e.g. quarterly, submitted for approval. The capital request may include a forecast of rolling hardware. A forecast of rolling hardware is taken to mean a forecast for a current period e.g. quarter and a forecast for a next sequential period e.g. next quarter. However, the approval is requested only for the current period. A subsequent approval will normally be requested at a later time for the next sequential period, however at that time a new forecast for the next sequential period which may be different than the original forecast above, will be provided. A forecast of the second next sequential period will also be provided at that time but the requested approval request will be for only the first sequential period. Upon approval, the hardware is ordered and tracked.

Ordered hardware is received and added to inventory 23. It is then shipped to individuals located at various sites. Deployment 24 is scheduled. BIE applications are added as needed and the hardware is installed for the selected individuals. Old hardware is removed and appropriate asset transfer records are made.

A cascade/disposal process 25 determines whether the old workstation is usable by another individual and if so it is redeployed to the next scheduled person. If not usable, then arrangements are made and record changes made to dispose as unusable.

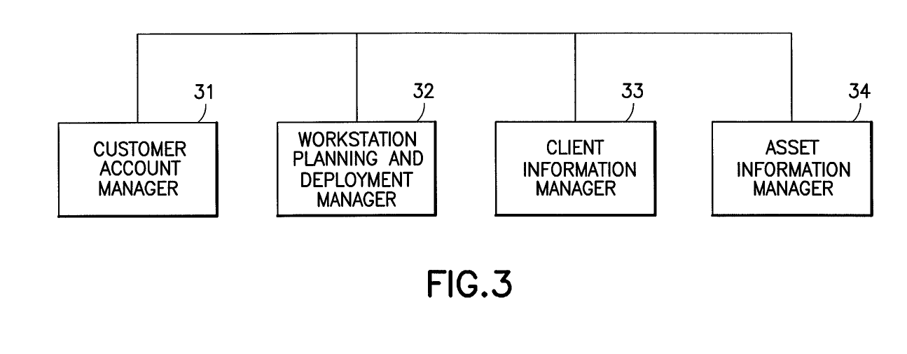

In FIG. 3 there is shown an integrated lifecycle management tool for workstations in accordance with the present invention. Customer account manager application 31 comprises software for defining financial relationships of owners of workstations. For example, the business unit or department to which an individual owner belongs may be defined. Which information technology representative handles that owner may also be defined. Which finance group or which BIE approves capital requests for that individual owner may be defined.

Customer account manager application 31 is coupled to workstation planning and deployment manager application 32. Capital plans for workstations are defined as described above using workstation planning and deployment manager application 32 which by necessity accesses the financial relationships defined in customer account manager application 31, or receives updates from customer account manager application 31.

Client information manager (CIM) 33 maintains information about owners of workstations such as the owner's name and location of the workstation. CIM is also adapted to accept entry of deployment information of workstations to owners. Both owner information and deployment information is shared with workstation planning and deployment manager 32 in order to facilitate formulation of capital plans.

Asset information manager application (AIM) 34 maintains detailed capital asset information for the workstations such as serial numbers and book values. AIM is also adapted to receive deployment updates on capital assets as they occur from CIM. AIM may also provide asset information updates to CIM. Other applications may also be used separately or in concert with elements 31, 32, 33, and 34 without departing from the present invention.

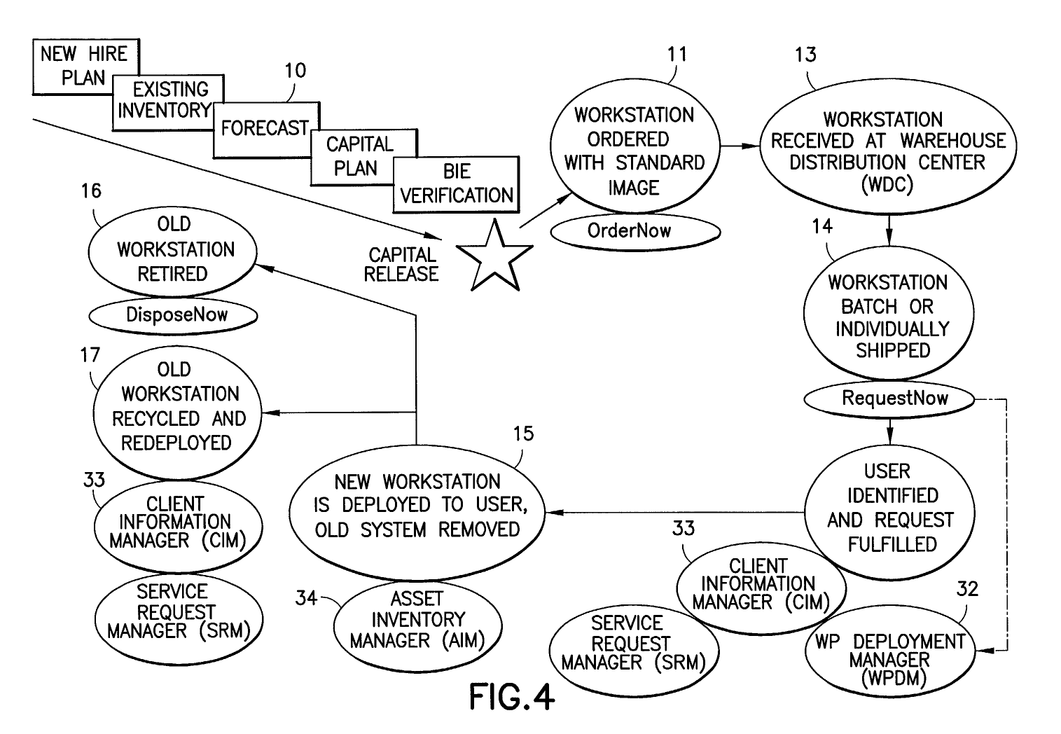

In FIG. 4 there is shown further detail on which process steps of the present invention are handled by the applications shown in FIG. 3. For example, workstation planning and deployment manager application 32 is used to provide the shipping of workstation step 14. CIM 33 is used for both fulfillment and redeployment 17 activities. AIM 34 is used in the deployment and old system removal step 15.

While there have been shown and described what are at present considered the preferred embodiments of the invention, it will be obvious to those skilled in the art that various changes and modifications may be made therein without departing from the scope of the invention as defined by the appended claims.

What is claimed is:

1. An integrated lifecycle management tool for workstations, comprising:
a customer account manager application for defining financial relationships of owners of said workstations;
a workstation planning and deployment manager application for defining capital plans for said workstations;
a client information manager application for maintaining information about said owners of said workstations and for entering deployment information of workstations to owners; and
an asset information manager application for maintaining capital asset information for said workstations, and for receiving updates from said client information manager application.

2. The tool of claim 1, wherein said customer account manager application is adapted to correlate departments of said owners to IT representatives.

3. The tool of claim 1, wherein said customer account manager application is adapted to correlate departments of said owners to a business area.

4. The tool of claim 1, wherein said workstation planning and deployment manager application is adapted to allocate an available inventory of workstations.

5. The tool of claim 1, wherein said client information manager application is adapted to reassign a usable workstation to another owner.

6. The tool of claim 1, wherein said client information manager application is adapted to initiate disposal of a replaced workstation.

7. The tool of claim 1, wherein said asset information manager application is adapted to receive net book values for said workstations from a financial system.

8. A method of lifecycle management of workstations, said method comprising the steps of:
defining financial relationships of owners of said workstations;
defining capital plans for said workstations;
maintaining information including deployment information about said owners of said workstations; and
maintaining capital asset information for said workstations, including receiving updates based on said deployment information.

9. The method of claim 8, further comprising the step of correlating departments of said owners to IT representatives.

10. The method of claim 8, further comprising the step of correlating departments of said owners to a business area.

11. The method of claim 8, further comprising the step of allocating an available inventory of workstations to said owners.

12. The method of claim 11, further comprising the step of reassigning a usable workstation to another owner.

13. The method of claim 11, further comprising the step of initiating disposal of a replaced workstation.

14. A computer system for managing lifecycles of workstations, said system comprising:
means for defining financial relationships of owners of said workstations;
means for defining capital plans for said workstations;
means for maintaining information including deployment information about said owners of said workstations; and
means for maintaining capital asset information for said workstations, including receiving updates based on said deployment information.

15. The computer system of claim 14, further comprising means for allocating an available inventory of workstations to owners.

16. The computer system of claim 14, further comprising means for receiving net book values for said workstations from a financial system.

17. A computer program product for instructing a processor to manage lifecycles of workstations, said computer program product comprising:
a compute readable medium;
first program instruction means for defining financial relationships of owners of said workstations;
second program instruction means for defining capital plans for said workstations;
third program instruction means for maintaining information including deployment information about said owners of said workstations; and
fourth program instruction means for maintaining capital asset information for said workstations, including receiving updates based on said deployment information; and wherein
all said program instruction means are recorded on said medium.

18. The computer program product of claim 17, further comprising fifth program instruction means for allocating an available inventory of workstations to owners.

19. The computer program product of claim 17, further comprising fifth program instruction means for initiating disposal of replaced workstations.

20. The computer program product of claim 17, further comprising fifth program instruction means for receiving net book values for said workstations from a financial system.
